(19) United States
(12) Patent Application Publication
(10) Pub. No.: US 2026/0135196 A1
(43) Pub. Date: May 14, 2026

(54) Battery Module and Battery Pack Including Protective Member

(71) Applicant: SK On Co., Ltd., Seoul (KR)

(72) Inventors: Bon Seok KU, Daejeon (KR); Jin Po PARK, Daejeon (KR); Hoe Wook CHOI, Daejeon (KR); Hui Jun SHIN, Daejeon (KR); Chong Pyo HONG, Daejeon (KR); Dae Gyun HWANG, Daejeon (KR)

(21) Appl. No.: 19/372,440

(22) Filed: Oct. 29, 2025

(30) Foreign Application Priority Data
Nov. 8, 2024 (KR) 10-2024-0157934

(51) Int. Cl. H01M 10/658; H01M 50/211; H01M 50/258; H01M 50/507; H01M 50/517; H01M 50/588; H01M 50/593

(52) U.S. Cl. CPC H01M 10/658; H01M 50/211; H01M 50/258; H01M 50/507; H01M 50/517; H01M 50/588; H01M 50/593

(57) ABSTRACT

A battery module includes a housing including an accommodation space, a cell assembly accommodated in the accommodation space and including a plurality of battery cells, and a busbar assembly disposed on at least one side of the cell assembly, wherein the busbar assembly includes a busbar electrically connecting the plurality of battery cells to each other, a support frame supporting the busbar, and a protective member disposed between the busbar and the support frame.

### CROSS-REFERENCE TO RELATED APPLICATION(S)

This patent document claims the priority and benefits of Korean Patent Application No. 10-2024-0157934 filed on Nov. 8, 2024, the disclosure of which is incorporated herein by reference in its entirety.

### TECHNICAL FIELD

The disclosure and implementations disclosed in this patent document generally relate to a battery module and a battery pack including a protective member.

### BACKGROUND

Secondary batteries, unlike primary batteries, may conveniently be charged with and discharged of electricity, and therefore, have come to prominence as a power source for various mobile devices and electric vehicles. Rechargeable and dischargeable secondary batteries, unlike primary batteries, have been applied to a wide range of applications, including digital cameras, mobile phones, laptops, hybrid vehicles, electric vehicles, and energy storage systems (ESS).

Such secondary batteries may include battery cells, each of which includes an electrode assembly, which is formed by stacking a positive electrode plate, a negative electrode plate, and a separator or winding them into a roll and being accommodated within a case. A plurality of battery cells may be stacked in a predetermined direction and accommodated in a battery module or battery pack.

Meanwhile, if thermal runaway occurs in a battery cell, gases and flames including conductive foreign matter may spread to neighboring battery cells, potentially causing a large-scale fire or explosion.

Thus, research into a protective structure that may delay the spread of flames originating from a single battery cell to neighboring battery cells to a maximum extent has been conducted.

### SUMMARY

The present disclosure may be implemented in some embodiments to delay the spread of gas or flames originating from a single battery cell to neighboring battery cells to a maximum extent.

The present disclosure may also be implemented in some embodiments to prevent or reduce the passage of gas or flames through a busbar assembly.

Meanwhile, the battery module and battery pack of the present disclosure may be widely applied to devices within green technology fields, such as electric vehicles, battery charging stations, and solar and wind power generation using batteries. Furthermore, the battery module and battery pack of the present disclosure may be used in eco-friendly electric vehicles, hybrid vehicles, and other vehicles that prevent climate change by reducing air pollution and greenhouse gas emissions.

In some embodiments of the present disclosure, a battery module includes: a housing including an accommodation space; a cell assembly accommodated in the accommodation space and including a plurality of battery cells; and a busbar assembly disposed on at least one side of the cell assembly, wherein the busbar assembly includes: a busbar electrically connecting the plurality of battery cells to each other; a support frame supporting the busbar; and a protective member disposed between the busbar and the support frame.

The protective member may include at least one of material selected from the group consisting of mica, ceramic, glass fiber, and silica aerogel.

A melting point of the protective member may be higher than a melting point of the support frame.

The protective member may be disposed to face the cell assembly with the support frame interposed therebetween.

The support frame may include a support fixing portion protruding toward the busbar to fix the busbar.

The support fixing portion may penetrate through the busbar and the protective member such that at least a portion of the support fixing portion may be disposed between the busbar and the housing, the busbar may include a busbar hole through which the support fixing portion passes, and the protective member may include a protective hole communicating with the busbar hole and allowing the support fixing portion to pass through the protective hole.

The support fixing portion may include: a support portion disposed between the busbar hole and the protective hole; and a head portion disposed at an end of the support portion and facing the support frame with the busbar and the protective member interposed therebetween.

A diameter of the protective hole and a diameter of the busbar hole may be smaller than a diameter of the head portion and larger than a diameter of the support portion.

Each of the plurality of battery cells may include a lead tab protruding toward the busbar and at least partially inserted into the busbar assembly, the busbar may include a busbar slit into which the lead tab is inserted, the support frame may include a frame slit through which the lead tab passes, and the protective member may include a protective slit through which the lead tab passes, the protective slit communicating with the busbar slit and the frame slit.

A width of the protective slit may be smaller than a width of the frame slit.

The protective member may include an inclined portion formed such that a width of the protective slit decreases in a direction from the cell assembly toward the busbar.

The protective member may include at least one protrusion protruding from a surface facing the busbar toward the busbar and inserted into the busbar.

The cell assembly may include at least one thermal blocking member disposed between the plurality of battery cells, and the thermal blocking member may be inserted into a blocking groove formed in the support frame.

Each of the busbar and the protective member may be provided in plural, and the blocking groove may be disposed between a plurality of the busbars and between a plurality of the protective members.

In some embodiments of the present disclosure, a battery pack includes: a pack case; and at least one battery module disposed in the pack case, wherein the battery module includes: a housing including an accommodation space; a cell assembly accommodated in the accommodation space and including a plurality of battery cells having a lead tab disposed on at least one side; and a busbar assembly disposed on at least one side of the cell assembly and electrically connecting the plurality of battery cells, wherein the busbar assembly includes: a busbar electrically connecting the plurality of battery cells to each other; a support frame supporting the busbar; and a protective member disposed between the busbar and the support frame.

### BRIEF DESCRIPTION OF DRAWINGS

Certain aspects, features, and advantages of the present disclosure are illustrated by the following detailed description with reference to the accompanying drawings.

FIG. 1 is a perspective view of a battery module according to an embodiment of the present disclosure;

FIG. 2 is an exploded view of a battery module according to an embodiment of the present disclosure;

FIG. 3 is an exploded view of a busbar assembly according to an embodiment;

FIG. 4 is an external view of a busbar assembly;

FIG. 5 is a cross-sectional view taken along line I-I′ of FIG. 4;

FIG. 6 is a cross-sectional view taken along line II-II′ of FIG. 4;

FIG. 7 is an embodiment of portion A of FIG. 6;

FIG. 8 is another embodiment of portion A of FIG. 6;

FIG. 9 is an embodiment of portion B of FIG. 6;

FIG. 10 is a diagram illustrating delayed heat propagation according to an embodiment; and

FIG. 11 is a perspective view of a battery pack according to an embodiment of the present disclosure.

### DETAILED DESCRIPTION

Hereinafter, the present disclosure will be described in detail with reference to the drawings.

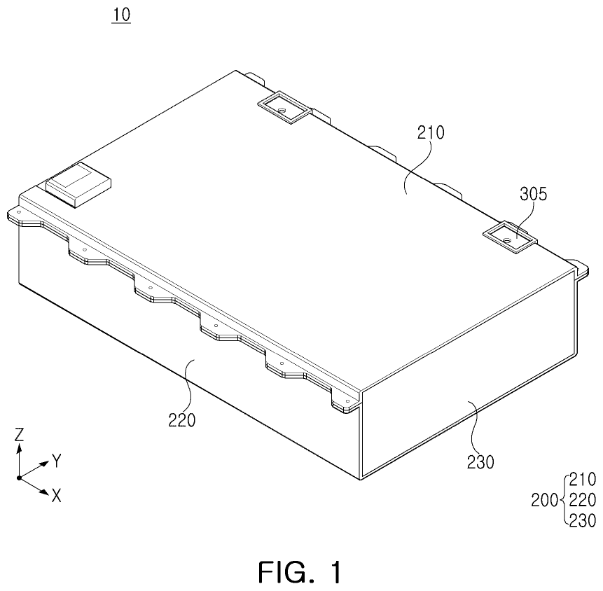

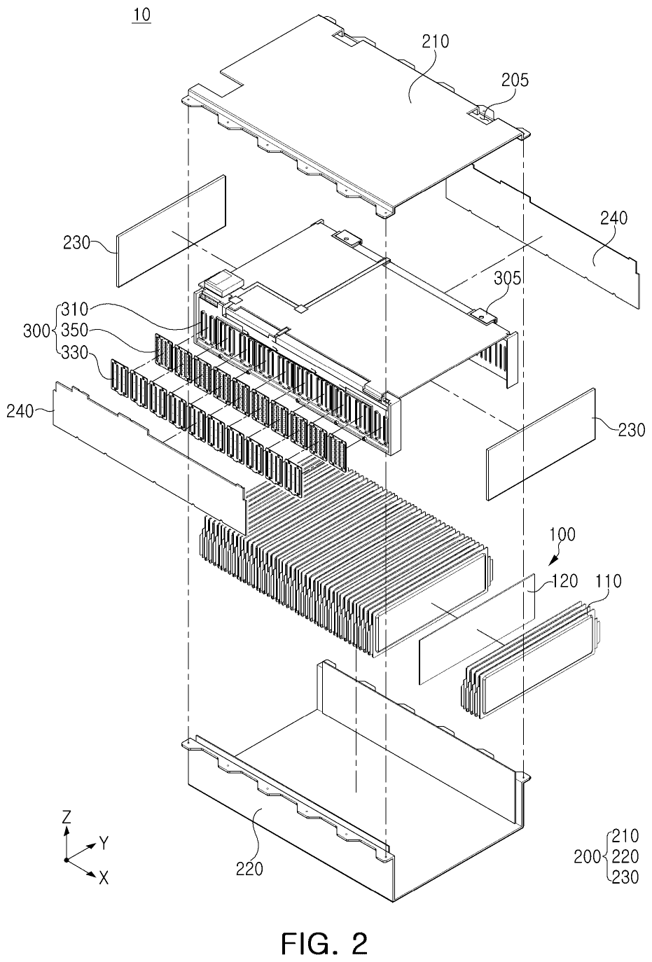

FIG. 1 is a perspective view of a battery module according to an embodiment of the present disclosure. FIG. 2 is an exploded view of a battery module according to an embodiment of the present disclosure.

Referring to FIGS. 1 and 2 together, a battery module 10 according to an embodiment of the present disclosure may include a housing 200, a cell assembly 100 accommodated in the housing 200, and a busbar assembly 300 disposed on at least one side of the cell assembly 100. Specifically, the battery module 10 according to an embodiment of the present disclosure may include the housing 200 including an accommodation space, the cell assembly 100 disposed in the accommodation space and including a plurality of battery cells 110, and the busbar assembly 300 disposed on at least one side of the cell assembly 100. Here, the busbar assembly 300 of the present disclosure may include a busbar 330 electrically connecting a plurality of battery cells 110 to each other, a support frame 310 supporting the busbar, and a protective member 350 disposed between the busbar 330 and the support frame 310. Each component will be described in detail below.

The housing 200 may include an upper cover 210 disposed above (+Z-axis) the cell assembly 100 and covering the cell assembly 100, a lower cover 220 facing the upper cover 210 and supporting the cell assembly 100, and a side cover 230 disposed in a portion not covered by the upper cover 210 and the lower cover 220. Meanwhile, in the drawing, the upper cover 210 and the lower cover 220 are illustrated as having a “[” shape with at least a portion thereof bent. However, the present disclosure is not limited thereto, and the upper cover 210 and the lower cover 220 may be provided to have a simple plate shape.

Furthermore, according to an embodiment, the housing 200 may further include an insulating cover 240 facing the busbar assembly 300 and including an electrically insulating material. The insulating cover 240 may be disposed between a cover (the lower cover 220 in the drawing) facing the busbar assembly 300 and the busbar assembly 300, thereby preventing an electrical short-circuit therebetween.

According to an embodiment, the housing 200 may include a terminal hole 205 exposing the terminal 305 of the busbar assembly 300 externally. The terminal 305 may include an electrically conductive material, such as metal. The terminal 305 may be connected to at least one of the busbars 330 so as to be electrically connected to an external power source of the battery module 10. The terminal 305 may be exposed externally through the terminal hole 205 so as to be electrically connected to the external power source. In the drawing, the terminal hole 205 is illustrated as being formed in the upper cover 210. However, this is for ease of understanding, and the present disclosure is not limited thereto.

The cell assembly 100 may include a plurality of battery cells 110. The battery cell 110 of the present disclosure may include a case accommodating an electrode assembly therein and a lead tab (112, see FIG. 6) disposed on at least one side of the case. The lead tab 112 may have one side connected to the electrode assembly within the case and the other side protruding outwardly of the case so as to be electrically connected to the busbar 330. As described below with reference FIG. 6, the lead tab 112 may be inserted into the busbar assembly 300 and electrically connected to the busbar 330.

The electrode assembly may be configured such that the positive and negative electrode plates are stacked with wide surfaces thereof facing each other with the separator interposed therebetween. The separator may be configured to prevent an electrical short-circuit between the positive and negative electrode plates and to facilitate ion flow. For example, the separator may include a porous polymer film or porous nonwoven fabric. Furthermore, the electrode assembly may be accommodated in the case in various manners, such as stacking, zigzag folding (Z-folding), or stack-folding, in a jelly roll configuration formed by winding in a predetermined direction. Furthermore, the battery cell 110 may be a lithium-ion secondary battery, but is not limited thereto. For example, the battery cell may be a nickel-cadmium electrochemical cell, nickel-metal hydride battery, or nickel-hydrogen battery that may be charged with or discharged of electricity.

The battery cell 110 of the present disclosure may be provided as a pouch-type, prismatic-type, or cylindrical-type battery cell, depending on the structure of the case. While the drawing illustrates the battery cell 110 as a pouch cell with a pouch-shaped case, the present disclosure is not limited thereto, and prismatic or cylindrical-type battery cell may also be used.

Furthermore, the cell assembly 100 may further include a thermal blocking member 120 disposed between the plurality of battery cells 110. The thermal blocking member 120 may include a heat-resistant material. For example, the thermal blocking member 120 may include at least one material selected from the group consisting of mica, ceramic, glass fiber, and silica aerogel. However, the thermal blocking member 120 of the present disclosure is not limited to the materials described above, and any material that may be disposed between the plurality of battery cells 110 and functions to prevent or reduce heat propagation between adjacent battery cells 110 may be considered the thermal blocking member 120 of the present disclosure. Meanwhile, since the thermal blocking member 120 of the present disclosure functions to prevent or minimize heat propagation between adjacent cells 110, the thermal blocking member 120 may also be referred to as a thermal barrier. Furthermore, as described below with reference to FIG. 6, at least one side of the thermal blocking member 120 may be inserted into the busbar assembly 300 to prevent or reduce heat propagation between adjacent battery cells 110.

Hereinafter, the busbar assembly 300 of the present disclosure will be described in detail with reference to the drawings.

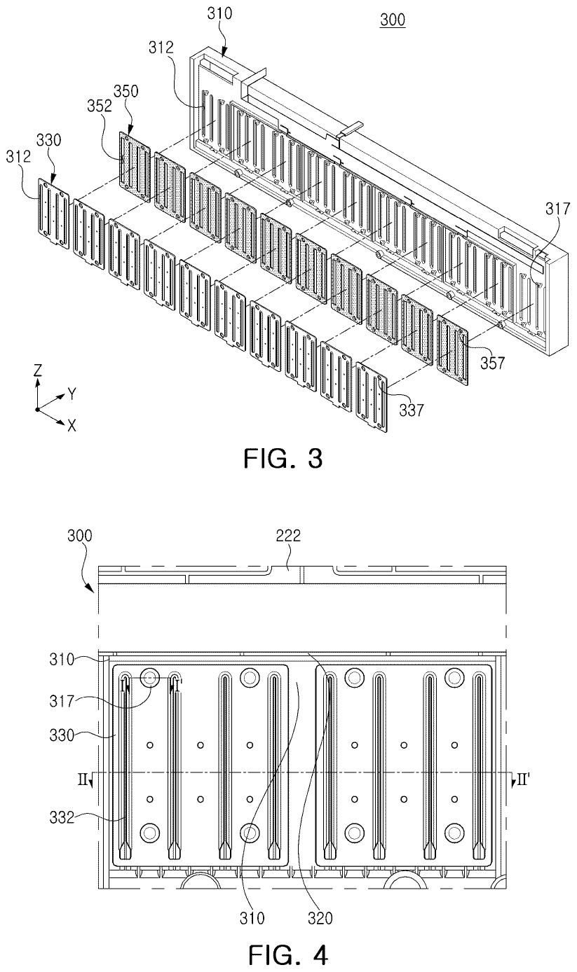

FIG. 3 is an exploded view of a busbar assembly according to an embodiment, and FIG. 4 is a view of the busbar assembly viewed from the external side. In the present disclosure, the “external side of the busbar assembly 300” may refer to a space between the housing 200 and the busbar assembly 300, and an “internal side of the busbar assembly 300” may refer to a space between the busbar assembly 300 and the cell assembly 100.

Referring to FIGS. 3 and 4 together, the busbar assembly 300 may include a support frame 310, a busbar 330 coupled to the support frame 310, and a protective member 350 disposed therebetween.

The support frame 310 is disposed between the busbar 330 and the cell assembly 100, thereby preventing a short-circuit between the busbar 330 and the battery cell 110. The support frame 310 may include an electrically insulating material. According to an embodiment, the support frame 310 may include a frame slit 312 through which the lead tab 112 passes and a support fixing portion 317 fixing the busbar 330.

At least one busbar 330 may be disposed on the support frame 310 in an arrangement or stacking direction of the battery cells 110. The busbar 330 may be disposed to face the support frame 310 with the protective member 350 interposed therebetween. The busbar 330 may include an electrically conductive material, such as metal, and may be electrically connected to the lead tab 112. At least a portion of the busbar 330 may be electrically connected to the terminal 305 described above. In an embodiment, the busbar 330 may include a busbar slit 332 into which the lead tab 112 is inserted and a busbar hole 337 through which the support fixing portion 317 passes.

The protective member 350 may be disposed between the busbar 330 and the support frame 310. In other words, the protective member 350 may be disposed to face the cell assembly 100 with the support frame 310 interposed therebetween. Furthermore, at least one protective member 350 may be disposed in the arrangement or stacking direction of the battery cells 110. The number of protective members 350 may be the same as the number of busbars 330.

In an embodiment, the protective member 350 may include a heat-resistant material including at least one of material selected from the group consisting of mica, ceramic, glass fiber, and silica aerogel. Through this, the protective member 350 may delay the propagation of gas and heat between the external and internal sides of the busbar assembly 300.

According to an embodiment, a melting point of the protective member 350 may be higher than a melting point of the support frame. Therefore, even if the support frame 310 melts during thermal runaway, the protective member 350 may be disposed between the busbar 330 and the cell assembly 100 to prevent direct contact between the busbar 330 and the cell assembly 100.

Furthermore, according to an embodiment, the protective member 350 may include a protective slit 352 through which the lead tab 112 passes and a protective hole 357 through which the support fixing portion 317 passes.

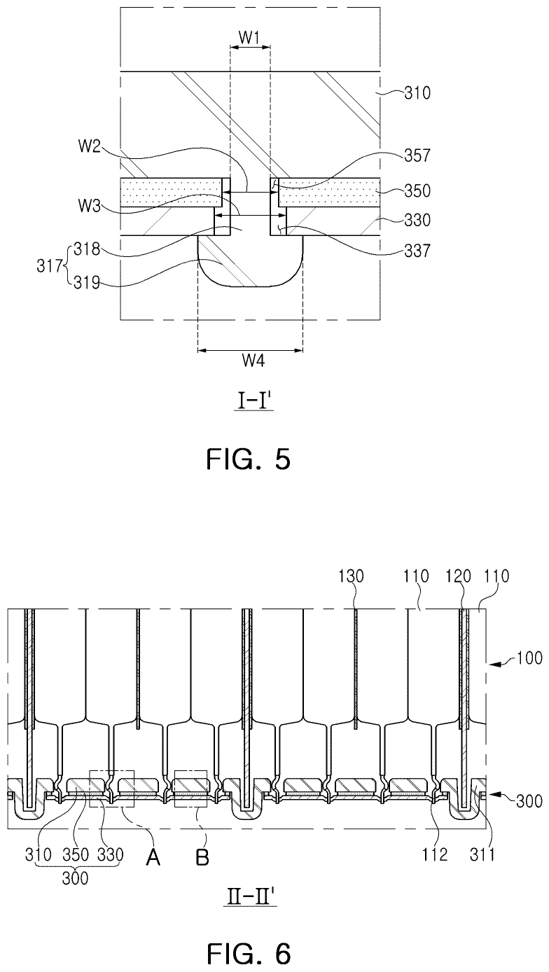

FIG. 5 is a cross-sectional view taken along line I-I′ of FIG. 4.

Referring to FIG. 5, the support frame 310 according to an embodiment may include the support fixing portion 317 protruding toward the busbar 330 to secure the busbar 330.

The support fixing portion 317 may penetrate through the busbar 330 and the protective member 350 such that at least a portion of the support fixing portion is disposed between the busbar 330 and the housing 200.

According to an embodiment, the support fixing portion 317 may protrude outwardly to penetrate through the busbar hole 337 and the protective hole 357 and have an outer end pressed or fused to secure the busbar 330 and the protective member 350. Specifically, the support fixing portion 317 may include a support portion 318 penetrating through the busbar 330 and the protective member 350 and a head portion 319 disposed at an outer end of the support portion 318. The head portion 319 may be formed by compressing or fusing the outer end of the support portion 318 so that a diameter W4 of the head portion 319 may be larger than a diameter W1 of the support portion 318. That is, the support fixing portion 317 may include the support portion 318 disposed between the busbar hole 337 and the protective hole 357, and the head portion 319 disposed at an end of the support portion 318 and facing the support frame 310 with the busbar 330 and the protective member 350 interposed therebetween. Through this structure, the busbar 330 and the protective member 350 may be inserted and secured between the head portion 319 of the support fixing portion 317 and the support frame 310. Since the protective member 350 may be inserted and secured between the busbar 330 and the support frame 310, there is no need to couple the protective member 350 by a separate member, thereby increasing the efficiency of the assembly process, according to the present disclosure.

Furthermore, the diameter of the support portion 318 is not particularly limited, as long as it may pass through the busbar 330 and the protective member 350, while securing them. That is, a diameter W2 of the protective hole 357 and a diameter W3 of the busbar hole 337 may be formed to be smaller than the diameter W4 of the head portion 319 of the support fixing portion 317 and larger than the diameter of the support portion 318. In addition, although the drawing illustrates that the diameter W3 of the busbar hole 337 is larger than the diameter W2 of the protective hole 357, this is for ease of understanding and the present disclosure is not limited thereto.

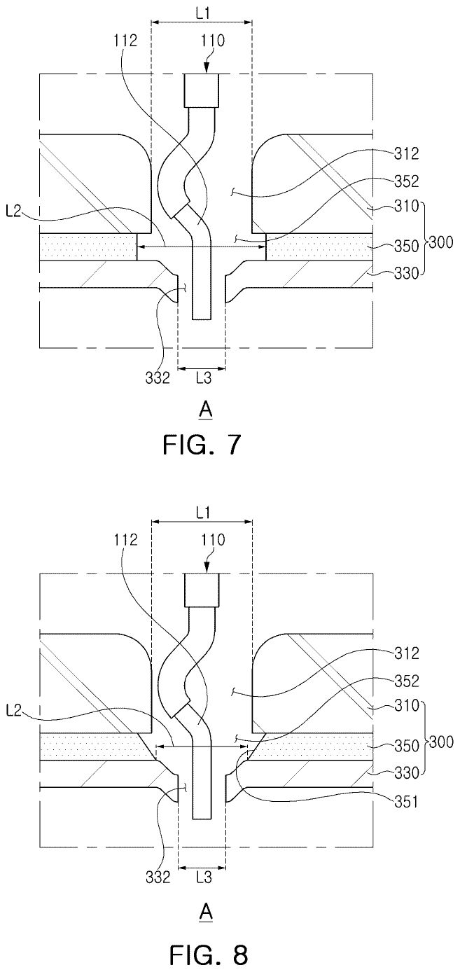

FIG. 6 is a cross-sectional view taken along line II-II′ of FIG. 4, FIG. 7 illustrates an embodiment of portion A of FIG. 6, and FIG. 8 illustrates another embodiment of portion A of FIG. 6.

Referring to FIGS. 6 and 8 together, the lead tab 112 may be at least partially inserted into the busbar assembly 300. As described above, according to an embodiment, the busbar 330 may include a busbar slit 332 into which the lead tab 112 is inserted, the support frame 310 may include a frame slit 312 through which the lead tab 112 passes, and the protective member 350 may include a protective slit 352 through which the lead tab 112 passes and which communicates with the busbar slit 332 and the frame slit 312.

Specifically, the lead tab 112 may sequentially pass through the frame slit 312 and the protective slit 352 and be at least partially inserted into the busbar slit 332 to be electrically connected to the busbar 330. Meanwhile, while the drawing illustrates that the lead tab 112 is spaced apart from the busbar 330, this is for ease of understanding, and the lead tab 112 may be in contact with and electrically connected to the busbar 330.

A width L2 of the protective slit 352 may be smaller than a width L1 of the frame slit 312. Through this, flames or gas may be prevented or reduced from passing through the frame slit 312 during thermal runaway. While FIG. 7 illustrates that the width L2 of the protective slit 352 is larger than the width L1 of the frame slit 312, this is merely an example for ease of understanding, and the present disclosure is not limited to the drawing. Furthermore, while the drawing illustrates that the width L2 of the protective slit 352 is larger than a width L3 of the busbar slit 332, the present disclosure is not limited thereto.

Referring to FIG. 8, the protective member 350 according to an embodiment may include an inclined portion 351 formed so that the width of the protective slit 352 decreases in a direction from the cell assembly 100 toward the busbar 330 (i.e., toward the outside). The inclined portion 351 may increase a contact area of a surface facing the cell assembly 100.

Meanwhile, the protective member 350 of the present disclosure may be fitted and coupled to the busbar 330 and the support frame 310 by the support fixing portion 317. Alternatively, the protective member 350 may be directly coupled to the busbar 330.

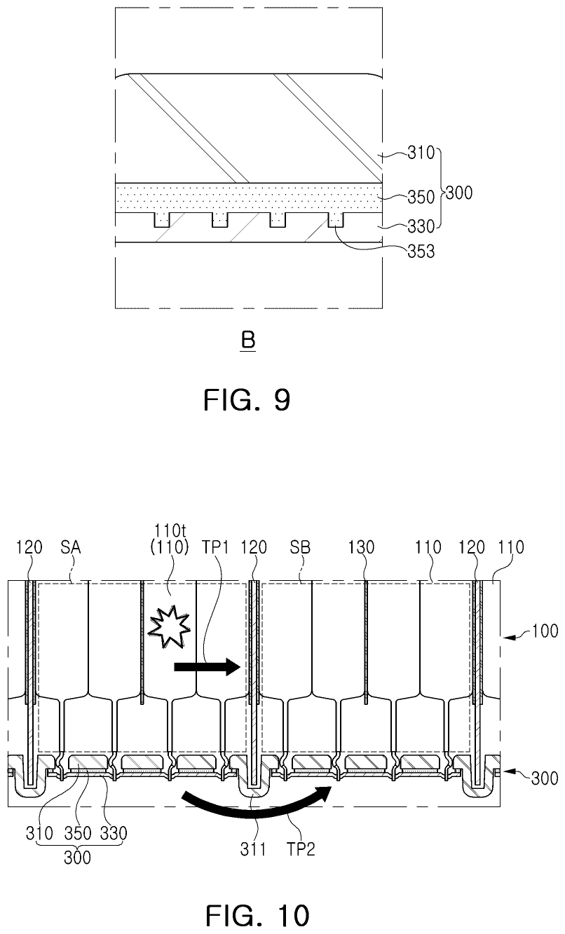

FIG. 9 illustrates an embodiment of portion B of FIG. 6.

Referring to FIG. 9, the protective member 350 according to an embodiment may include at least one protrusion 353 protruding outwardly from a surface facing the busbar 330 and inserted into the busbar 330. That is, the protective member 350 may be directly inserted into the busbar 330 via the protrusion 353 and be coupled to the busbar 330. This may enhance the coupling integrity between the busbar 330 and the protective member 350. Furthermore, the protective member 350 may be maintained in a state of being coupled to the busbar 330 even when the support frame 310 melts during thermal runaway, and thus, the busbar 330 may be prevented from direct contact with the cell assembly 100.

Meanwhile, the thermal blocking member 120 and protective member 350 of the present disclosure may delay the spread of flames or gas to neighboring battery cells 110 during thermal runaway to a maximum extent.

FIG. 10 is a diagram illustrating a delay in heat propagation according to an embodiment.

Referring to FIG. 10, the cell assembly 100 may include at least one thermal blocking member 120 disposed between the plurality of battery cells 110. Meanwhile, the cell assembly 100 according to an embodiment of the present disclosure may further include an elastic member 130 disposed between at least one of the plurality of battery cells 110 or the thermal blocking member 120. The elastic member 130 may include an elastic material and may absorb expansion pressure of the battery cells 110.

The support frame 310 may include a blocking groove 311 into which the thermal blocking member 120 of the cell assembly 100 is inserted. That is, at least one end of the thermal blocking member 120 may be inserted into the blocking groove 311 of the support frame 310. Through this, the inside of the battery module 10 may be divided into a plurality of spaces SA and SB like a sort of compartment based on the thermal blocking member 120.

In addition, according to an embodiment, the blocking groove 311 may be disposed between a plurality of protective members 350 and a plurality of busbars 330. At least a portion of the blocking groove 311 may protrude outwardly to prevent or delay the spread of flames or heat to adjacent protective members 350 and adjacent busbars 330.

In the drawing, the space disposed on one side of the thermal blocking member 120 is defined as a first space SA, and the space disposed on the other side of the thermal blocking member 120 is defined as a second space SB.

As illustrated in the drawing, it may be assumed that a trigger cell 110t experiencing thermal runaway among the plurality of battery cells 110 is disposed in the first space SA. Here, flames or gases occurring in the first space SA may propagate through at least one of a first propagation path TP1 along which flames or gas flows directly from the inside of the busbar assembly 300 in the stacking direction of the battery cells 110 or a second propagation path TP2 along which flames or gas propagates from the outside of the busbar assembly 300.

According to the present disclosure, the propagation of flames or gases flowing through the first propagation path TP1 may be prevented or delayed by the thermal blocking member 120 inserted into the blocking groove 311. Furthermore, the propagation of flames or gases flowing through the second propagation path TP2 may be prevented or delayed by the structure of the protective member 350 described above with reference to FIGS. 6 to 8. Through this, the battery module 10 of the present disclosure may delay the propagation of flames or gases generated by any one battery cell 110 to a maximum extent.

Meanwhile, while the first propagation path TP1 through the thermal blocking member 120 has been described as an example in FIG. 10, the present disclosure is not limited thereto, and any structure capable of preventing the propagation of flames or gases through the second propagation path TP2 through the protective member 350 may be used. In other words, any structure including the protective member 350 may be considered to be within the scope of the present disclosure, and the present disclosure is not limited to the presence of the thermal blocking member 120 or the structure of the blocking groove 311.

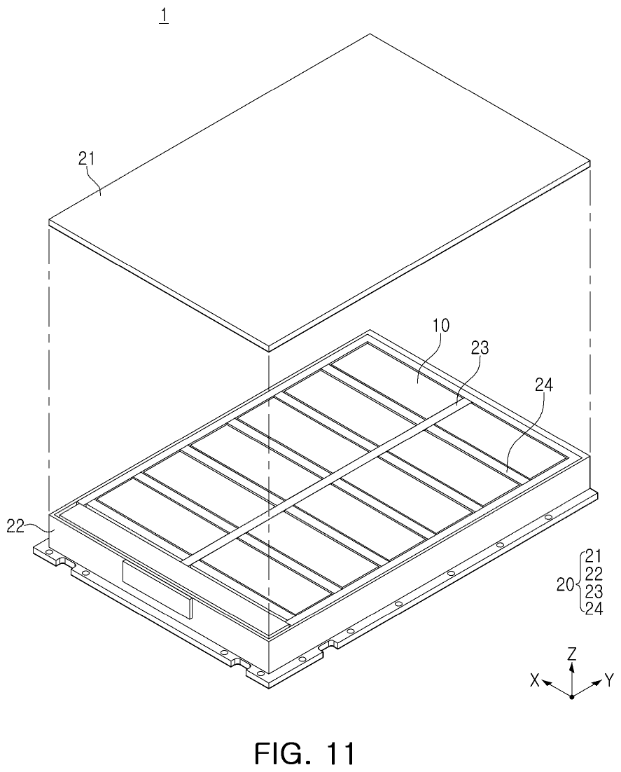

FIG. 11 is a perspective view of a battery pack according to an embodiment of the present disclosure. The redundant descriptions as those given above with reference to FIGS. 1 through 10 are omitted.

Referring to FIG. 11, a battery pack 1 according to an embodiment may include the battery module 10 described above with reference to FIGS. 1 through 10. The battery pack 1 may include a pack case 20 and at least one battery module 10 disposed in the pack case 20. Here, the battery module 10 may be the battery module 10 described above with reference to FIGS. 1 to 10. Specifically, the battery pack 1 of the present disclosure may include the pack case 20 having a loading space and at least one battery module 10 loaded in the loading space.

The pack case 20 may include a pack cover 21 covering the upper (+Z-axis) side of the battery module 10 and a pack frame 22 facing the pack cover 21 and accommodating the battery module 10.

Furthermore, the pack case 20 may further include partitions 23 and 24 dividing the loading space into a plurality of spaces. The partitions 23 and 24 may include a first partition 23 crossing the loading space and a second partition 24 disposed between the plurality of battery modules 10.

According to an embodiment, the battery pack 1 may include a controller (not shown) for controlling the battery modules 10 loaded in the loading space. The controller may include a battery management system (BMS) measuring the voltage, temperature, etc. of the battery modules 10 and managing input/output.

According to an embodiment of the present disclosure, the battery module and the battery pack in which the propagation of gases or flames occurring in any one battery cell to a neighboring battery cell may be delayed to a maximum extent may be provided.

According to an embodiment of the present disclosure, the battery module and the battery pack in which the passage of gases or flames through the busbar assembly may be prevented or reduced may be provided.

Although the embodiments of the present disclosure have been described above, the scope of the present disclosure is not limited thereto and it will be apparent to those skilled in the art that various modifications and variations may be made within the scope not departing from the technical idea of the present disclosure described in the claims. For example, the present disclosure may be implemented by deleting some of the components in the above-described embodiments, and the respective embodiments may be implemented in combination with each other.

The above-described contents are merely examples adopting the principles of the present disclosure, and other components may be further included without departing from the scope of the present disclosure.

What is claimed is:

1. A battery module comprising:
a housing including an accommodation space;
a cell assembly accommodated in the accommodation space and including a plurality of battery cells; and
a busbar assembly disposed on at least one side of the cell assembly,
wherein the busbar assembly includes:
a busbar electrically connecting the plurality of battery cells to each other;
a support frame supporting the busbar; and
a protective member disposed between the busbar and the support frame.

2. The battery module of claim 1, wherein the protective member includes at least one material selected from the group consisting of mica, ceramic, glass fiber, and silica aerogel.

3. The battery module of claim 1, wherein a melting point of the protective member is higher than a melting point of the support frame.

4. The battery module of claim 1, wherein the protective member is disposed to face the cell assembly with the support frame interposed therebetween.

5. The battery module of claim 1, wherein the support frame includes a support fixing portion protruding toward the busbar to fix the busbar.

6. The battery module of claim 5, wherein
the support fixing portion penetrates through the busbar and the protective member such that at least a portion of the support fixing portion is disposed between the busbar and the housing,
the busbar includes a busbar hole through which the support fixing portion passes, and
the protective member includes a protective hole communicating with the busbar hole and allowing the support fixing portion to pass through the protective hole.

7. The battery module of claim 6, wherein
the support fixing portion includes:
a support portion disposed between the busbar hole and the protective hole; and
a head portion disposed at an end of the support portion and facing the support frame with the busbar and the protective member interposed therebetween.

8. The battery module of claim 7, wherein a diameter of the protective hole and a diameter of the busbar hole are smaller than a diameter of the head portion and larger than a diameter of the support portion.

9. The battery module of claim 1, wherein
each of the plurality of battery cells includes a lead tab protruding toward the busbar and at least partially inserted into the busbar assembly,
the busbar includes a busbar slit into which the lead tab is inserted,
the support frame includes a frame slit through which the lead tab passes, and
the protective member includes a protective slit through which the lead tab passes, the protective slit communicating with the busbar slit and the frame slit.

10. The battery module of claim 9, wherein a width of the protective slit is smaller than a width of the frame slit.

11. The battery module of claim 9, wherein the protective member includes an inclined portion formed such that a width of the protective slit decreases in a direction from the cell assembly toward the busbar.

12. The battery module of claim 1, wherein the protective member includes at least one protrusion protruding from a surface facing the busbar toward the busbar and inserted into the busbar.

13. The battery module of claim 1, wherein the cell assembly includes at least one thermal blocking member disposed between the plurality of battery cells, and the thermal blocking member is inserted into a blocking groove formed in the support frame.

14. The battery module of claim 13, wherein each of the busbar and the protective member is provided in plural, and the blocking groove is disposed between a plurality of the busbars and between a plurality of the protective members.

15. A battery pack comprising:
a pack case; and
at least one battery module disposed in the pack case,
wherein the battery module includes:
a housing including an accommodation space;
a cell assembly accommodated in the accommodation space and including a plurality of battery cells having a lead tab disposed on at least one side; and
a busbar assembly disposed on at least one side of the cell assembly and electrically connecting the plurality of battery cells,
wherein the busbar assembly includes:
a busbar electrically connecting the plurality of battery cells to each other;
a support frame supporting the busbar; and
a protective member disposed between the busbar and the support frame.
